(19) United States
(12) Patent Application Publication
(10) Pub. No.: US 2003/0109630 A1
(43) Pub. Date: Jun. 12, 2003

(54) Microsphere adhesive formulations

(76) Inventors: Dawn E. Smith, Martinsville, NJ (US); Mark A. Conover, Annandale, NJ (US)

Correspondence Address: Cynthia L. Foulke, NATIONAL STARCH AND CHEMICAL COMPANY, 10 Finderne Avenue, Bridgewater, NJ, 08807-0500, US

(21) Appl. No.: 10/050,020

(22) Filed: Oct. 23, 2001

(51) Int. Cl. C08L 31/00

(52) U.S. Cl. 524/533; 524/515

(57) ABSTRACT

A pressure-sensitive adhesive comprising acrylic microspheres and at least two substantially different binders.

### FIELD OF THE INVENTION

The invention relates to a microsphere adhesive and method whereby adhesive performance may be modulated by adjusting the type and amount of binder.

### BACKGROUND OF THE INVENTION

Pressure sensitive adhesive (PSA) microspheres are known in the art to be useful in removable and repositionable pressure sensitive adhesive applications. Microsphere technology offers significant improvements over traditional removable PSAs, including clean removability from a variety of surfaces, consistent peel characteristics after roll storage, and multiple use (re-seal) capabilities.

Microspheres are conventionally made by suspension polymerization and they can be used as adhesives without further modification. However, microspheres are often formulated with a binder component that is intended to improve the anchorage of the product to facestocks, i.e., decrease transfer of the adhesive to the application surface.

Adhesive properties are influence by a number of factors. The adhesive tack of removable pressure sensitive adhesives may be controlled by adjusting the percentage of the facestock covered by the microspheres, the extent of crosslinking, and the size of the microspheres.

The composition of the microspheres is important. Prior art teaches that the monomers should be chosen to give microspheres with a glass transition temperature (Tg) below −20° C. in order to have pressure-sensitive adhesive properties (see, e.g., U.S. Pat. No. 3,691,140 and EP 0 868 497). The art also teaches that incorporating a small amount of polar monomer(s) improves microsphere anchorage (see, DE 3,544,882 and EP 0 209 337), but a high level of polar monomer reduces the tack (see, EP 0 868,497).

The microsphere tackiness can be deliberately reduced to the point of being “tack-free” by using multi-functional monomer as a crosslinking agent (see, U.S. Pat. No. 5,719,247). Hollow microspheres, especially acid-free hollow microspheres, are described in the art as having superior anchorage over solid microspheres (see, U.S. Pat. Nos. 4,968,562 and 5,045,569). These factors allow the adhesive formulator some flexibility in adhesive performance, but they do not give accurate control over PSA tack and peel.

Where a binder is used, the amount and type of binder are important. The binder can be a PSA emulsion polymer, but it does not have to be a PSA (see, U.S. Pat. No. 3,857,731). Low levels of binder can lead to poor anchorage while high levels of PSA binder are known to give higher peel products (see, EP 0 439 941 and U.S. Pat. No. 5,514,122).

U.S. Pat. No. 4,994,322 claims a binder consisting of an elactomeric backbone and high Tg pendant groups. This binder has high cohesive strength at relatively low molecular weights and therefore provides good spray properties without sacrificing adhesive performance. Other U.S. patents using this type of binder, i.e., one based on copolymerization of polystyrene macromer with other monomers, include U.S. Pat. Nos. 5,118,750, 5,502,108 and 5,502,108.

PSA's can also be made where the binder component completely covers the surface of the microspheres and in these products, the binder properties are important (see, U.S. Pat. Nos. 4,735,83 and 5,128,412). Ingredients, such as plasticisers and tackifiers can be added to increase tack.

Adhesive peel can be increased by applying a thicker layer of microsphere adhesive, especially if the facestock is textured. However, most adhesives converters have difficulty using the reverse approach, i.e., reducing the coat weight to obtain a lower tack product (application Ser. No. 09/690,525 and Utilizing Analytical Tools To Optimize Properties of Ultraremovables Based on Microsphere Technology. I. Brase, D. Smith and P. Walter, in December 2000 issue of Coater Laminator Technology, a special supplement to Converting Magazine).

Other components, when added in excess, can detract from adhesive performance. For example, excess surfactant can lead to foaming, which presents a coating problem, and loss of humidity resistance, which limits the usefulness of the product.

The above approaches give the specialty adhesives formulator some capability to tailor the adhesive performance to a given application. However, there is no simple way to adjust the tack and peel properties. Each approach either involves a significant change to the manufacturing process or it detracts from other properties such as shelf life or coatability. To implement these changes, extensive scale up studies and/or process optimization will be required. In addition, changes in raw materials can lead to additional regulatory testing and documentation.

There is thus a need in the art for a product and method whereby an adhesive formulator can tailor the adhesive performance of an adhesive to a given application. The current invention addresses this need.

### SUMMARY OF THE INVENTION

The present invention provides an acrylic microsphere pressure sensitive adhesive, the adhesive properties of which may be modulated for a predefined intended use. The invention enables the formulator to control adhesive performance over a wide range simply by adjusting the ratio of two binder components.

One aspect of the invention is directed to an adhesive comprising acrylic microspheres and a binder component, said binder component comprising at least two substantially different binders, said binders being present in amounts sufficient to modify the adhesive performance to a desired predetermined intended use. In the practice of the invention, at least a first binder and at least a second binder have Tgs that differ by at least about 20° C. More preferably, the Tgs of at least a first and at least a second binder differ by at least about 40° C., even more preferably the Tgs of at least a first and at least a second binder differ by at least about 60° C. or more. In a preferred embodiment of the invention the ratio of the low Tg binder to the high Tg binder is from about 1:10 to 20:1. More preferably, the low and high Tg binders are both emulsion polymer binders. Preferably, the total about of binder present in the adhesive is from about 2% to about 30% (dry weight basis). The adhesive of the invention comprises a microsphere suspension, a low Tg binder, a high Tg binder and may also, optionally, contain a thickener, a biocide and a defoamer.

Another aspect of the invention is directed to a method of modifying or adjusting the adhesive performance of an adhesive composition comprising acrylic microspheres and a first binder, said method comprising adding to said adhesive composition a modifying binder having substantially different properties than the binder originally present in the adhesive composition. In one embodiment the binder originally present in the adhesive composition is a low Tg binder and the modifying binder is a high Tg binder. In another embodiment, the binder originally present in the adhesive composition is a high Tg binder and the modifying binder is a low Tg binder.

### DETAILED DESCRIPTION OF THE INVENTION

The disclosures of all references cited herein are incorporated in their entireties by reference.

As used herein, the terms “low Tg” binder and “high Tg binder” are relative terms. The formulated adhesives of the invention have two binders having Tgs that are separated by at least about 20° C. For convenience, these binders may be referred to herein as low Tg and high Tg binders.

Unless otherwise indicated, all values are given on a dry weight basis.

The adhesives of the invention may be repositionable and/or removable. A repositionable adhesive, as used herein, means that a product coated with the adhesive has sufficient adhesive strength so as to remain stationary when applied to a surface to which it has been applied, but can be removed from the applied surface and, if desired, repositioned on the same or another surface, without adhesive residue being left on the surface. A repositionable adhesive is also a removable adhesive. It is to be understood that adhesives of the invention may be formulated to be removable only, i.e., the adhesive upon removal lacks sufficient tack to be applied at least a second time.

There are numerous references discussing the preparation of acrylic microspheres and acrylic microsphere pressure sensitive adhesives. Typically, microspheres are prepared via suspension polymerization of one or more free radically polymerizable monomers in the presence of surfactants and/or suspension stabilizers. Prior art methods are described in for example, U.S. Pat. No. 3,691,140, U.S. Pat. No. 4,166,152, U.S. Pat. No. 4,495,318, U.S. Pat. 4,598,112, U.S. Pat. No. 4,786,696, U.S. Pat. No. 4,839,416, U.S. Pat. No. 5,571,617, U.S. Pat. No. 5,656,705.

The microspheres used to prepare the adhesive of the invention are typically prepared by suspension polymerizing acrylic monomers in the presence of a polymerization initiator.

Initiator and acrylic monomer are emulsified in an aqueous solution and polymerized by suspension polymerization. Monomers can be homopolymerized or copolymerized. For purpose of example, the following components may be used in a microsphere polymerization process: 2-ethyl hexyl acrylate (as a monomer); t-butyl peroctoate (as initiator); deionized water (for continuous phase); polyacrylic acid (as stabilizer); ammonium hydroxide (for pH adjustment); ethylene diamine tetraacetic acid (as chelating agent).

While the use of 2-ethyl hexyl acrylate and t-butyl peroctoate is described in the examples, it is to be understood that the choice and the range of monomers and initiators that can be used in the microsphere polymerization process is extensive and can be chosen by one skilled in the art to tailor properties of the pressure sensitive adhesive microspheres for specific performance and/or application requirements, and can be tailored to provide removable adhesives with improved adhesive properties such as cohesive strength, peel adhesion and static shear.

Monomers which may be used to prepare microspheres useful in the practice of the invention include alkyl acrylates such as butyl acrylate, ethyl acrylate, methyl acrylate, and 2-ethylhexylacrylate, alkyl methacrylates such as methyl methacrylate and butyl methacrylate, polar comonomers such as acrylic acid, methacrylic acid, hydroxyethyl acrylate, hydroxypropyl acrylate, N-tertiary octylacrylamide, acrylonitrile, acrylamide, 1-vinyl-2-pyrrolidone, sodium vinyl sulfonate, vinyl esters such as vinyl acetate, vinyl propionate, vinyl neodecanoate, vinyl stearate and vinyl pivalate. Cross-linking monomers such as butanediol diacrylate and hexanediol diacrylate can also be used. Other useful monomers and combinations thereof which can be used in the practice of the invention would be apparent to one skilled in the art.

Initiators useful in microsphere polymerization include dialkyl peroxides such as lauroyl peroxide trade name Laurox from Akzo Nobel, diacyl peroxides such as dibenzoyl peroxide trade name Lucidol A75 from Elf Atochem, peroxyesters such as t-amyl peroxypivalate (Lupersol 554-M50 from Elf Atochem), t-butyl peroctoate (Luperox 26 from Elf Atochem and Trigonox 21 from Akzo Chemicals), azo compounds such as 2,2′-azobis(isobutyronitrile) trade name VAZO 64 and 2,2′-azobis(2-methylbutanenitrile) trade name VAZO 67, and 2,2′-azobis(2,4-dimethylpentanenitrile) trade name VAZO 52, all from DuPont. Other useful initiators and combinations thereof which can be used in the practice of the invention would be apparent to one skilled in the art.

The microspheres for use in the invention may be formulated to provide removable and/or repositionable pressure sensitive adhesives by any method known in the art. For example, adhesives may be formulated with the acrylic microspheres, binders, humectants, rheology modifiers, surfactants, stabilizers, tackifiers, fragrances, thickeners, defoamers and/or biocides.

The addition of a thickener improves coatability and provides additional stability for the adhesive formulation. Preferred thickeners include alkali soluble emulsions, such as Acrysol ASE-75, ASE-60 ASE-95 and ASE-108 (commercially available from Rohm and Haas) and polyacrylamide-based dispersions such as Viscalex AT-77 from Ciba Specialty Chemicals. The amount of thickener can be adjusted to achieve a desired viscosity for specific coating methods.

Conventional defoamers that can be used to practice the invention include agents sold under the trademark DEEFO 215 from Ultra Additives, Antifoam 1520, 1510 A and C from Dow Corning, and Foamaster 111, 333 and S from Henkel Corporation.

Biocides include Proxel DL by Avecia Biocides, Kathon LX and Kordec 50C by Rohm and Haas, and the like.

Other conventional additives may be used as appropriate for specific applications. Such additional components include tackifiers, such as SNOWTACK 301A, 342A, 385G and 348A from Akzo Nobel, TACOLYN 1070 from Hercules, AQUATAK 6080 from Arizona Chemical Company, and FORAL from Hercules, cross-linkers such as butanediol diacrylate and hexanediol diacrylate, as well as fillers, pigments, plasticisers, antioxidants, stabilizers, fire retardants, preservatives and rheology modifiers.

Binders are used mainly to improve anchorage of the microspheres, thus minimizing adhesive transfer. Useful binders should be compatible with the microspheres, and not affect removability of the final formulation. Examples include water-borne emulsion-polymerized acrylic or vinyl-acrylic polymers that are themselves pressure-sensitive adhesives, ethylene-vinyl acetate emulsions, polyurethane dispersions, natural rubber latex.

The use of two binders having substantially different Tg are required for use in the practice of the invention. By substantially different means that the Tg of the two binders used in the adhesive formulation are separated by at least about 20° C. For convenience, these binders are referred to as the low Tg binder component and the high Tg binder component. The binders are used in an amount and ratio effective to achieve a desired predetermined performance property.

Preferably, the binder component consists on one binder with a Tg below about −20° C. and the other with a Tg above about +40° C., with these binders mixed in a ratio of from 1:10 to 10:1. A preferred binder component for use in the practice of the invention comprises Carbotac 26222 (BF Goodrich) and Nacrylic 78-6408 (National Starch and Chemical). Other commercially available binders that can be used in the practice of the invention include Rhoplex N580 (Rohm and Haas), Acronal NV 146CR, Acronal NV 155CR, Acronal NV 189CR, Acronal NV 162CR, Acronal NN 171CR and Acronal NA 182CR (BASF). Further examples of modifying binders are shown in Table 1.

TABLE 1

| | | Physical | | | |
|---|---|---|---|---|---|
| | | properties | | | |
| Trade name | Manufacturer | solids | pH | Composition | Tg |
| NACRYLIC CP3600 | National Starch and | 50% | 8 | acrylic emulsion | 0° C. |
| | Chemical Company | | | | |
| NACRYLIC CP2550 | National Starch and | 50% | 8 | acrylic emulsion | +20° C. |
| | Chemical Company | | | | |
| NACRYLIC CP3650 | National Starch and | 45% | 8 | acrylic emulsion | +52° C. |
| | Chemical Company | | | | |
| Carbotac 26-222 | B.F. Goodrich | 50% | 8 | acrylic emulsion | −55° C. |
| Luphen D259U | BASF Corporation | 40% | 7 | polyether | −46° C. |
| | | | | polyurethane | |
| | | | | dispersion | |
| DUROSET ® C-325 | National Starch and | 53% | 5 | vinyl acetate | +30° C. |
| | Chemical Company | | | emulsion | |
| RESYN ® 1025 | National Starch and | 55% | 5 | vinyl acetate | +30° C. |
| | Chemical Company | | | emulsion | |
| DUROSET ® E-200 | National Starch and | 55% | 4.5 | ethylene vinyl | 0° C. |
| | Chemical Company | | | acetate (EVA) | |
| | | | | emulsion | |

Up to 95% of binder may be used in the practice of the invention. Typically the total amount of binder is from about 1 to about 60%, more preferably from about 2% to about 30%. Most preferably the total amount of binder will range from about 5% to about 20%.

By use of the invention described herein, the performance (e.g., tack, peel) of a stock microsphere adhesive can be modified. A low Tg polymer emulsion can be added in accordance with the invention to increase peel forces. A high Tg polymer emulsion can be added in accordance with the invention to decrease peel forces. If a delicate facestock is required to be used, lower peel forces will be required, and a high Tg binder can be added. Conversely, if a more aggressive adhesive is required for a particular application, a low Tg binder can be added.

Rather than stocking a large number of adhesives, the invention allows an adhesive user to conveniently stock only one or just a few types of adhesive, the performance of which may be modified by addition of binder component(s) depending on the facestock to be used and the performance properties desired. The claimed invention greatly extends the range of applications of a single product by enabling modification to create products of varying tack simply by adding a modifying component.

The adhesives of the invention find use in disposable articles of manufacture. By disposable article is meant an article designed to be used and disposed of after one or several uses, preferable after a single use. Such articles include direct food contact labels such as informational labels attached to fresh fruit, e.g., apples, oranges and the like, price labels, advertisements, promotional stickers, and resealable tabs for use in reclosure systems, e.g., bag endings, tissue packages and the like. This term also encompasses disposable absorbent articles and disposable absorbent garments such bed liners, bibs, feminine hygiene pads, incontinence pads, dress shields and nursing pads.

Included are articles having at least a front and a back side, which article has a permanent adhesive on one side (e.g., the back side) and a microsphere adhesive applied in accordance with the invention on the other side (e.g., the front side). Such articles find use, e.g., in permanent attachment of one side of the article to a product, from which article a coupon can be removeably released from the other side of the article upon the purchase of the product. Also contemplated is packaging that, depending on the way the package is designed to open, requires the use of both high and low tack adhesive products. Using the described invention, a single adhesive may be used for both adhesive requirements, merely by adding a modifying binder to the existing composition.

The present invention is further illustrated by the following Examples, but the particular materials and amounts thereof recited in these Examples, as well as other conditions and details, should not be construed as limiting the invention. All materials are commercially available or known to those skilled in the art unless otherwise stated or apparent. The following Examples are illustrative in nature and are not intended to limit the invention in any way.

### EXAMPLES

### Example 1

Microsphere Polymerization Process

Acrylic microspheres suitable for preparing microsphere adhesives were prepared as follows.

A 2L four-neck round-bottom flask was equipped with a 4-inch crescent-shaped paddle stirrer, a water-cooled condenser, a temperature probe, a hot plate and propylene glycol bath, and an addition funnel. 280 g 2-ethyl hexyl acrylate (monomer) was added to the round-bottom flask. 2.8 g t-butyl peroctoate (initiator, 50% active) was dispersed in a total of 9.2 g deionized water (half of which was used to rinse out the beaker used for mixing) and added to the flask. The contents of the flask were stirred at 250 rpm for 15 minutes. Agitation was stopped and 340 g de-ionized water and a stabilizer solution added using an addition funnel. The stabilizer composition used was prepared by adding 137.2 g of deionized water to 28g 10% sodium dodecyl benzene sulfonate solution (Rhodacal DS-4 from Rhone-Poulenc, diluted with de-ionized water to 10%) and stirring for five minutes with a magnetic stirrer. 6.72 g of Good-Rite K-702 (25% poly(acrylic acid) from B F Goodrich) was then added followed by five minutes of mixing. 1.4 g Versene 100 (35% active aqueous EDTA from Dow Chemical Company) was then added followed by five minutes of mixing. 1.4 g of Aerosol MA 80-I (80% sodium dihexyl sulfosuccinate in isopropanol, from Cytec Industries, Inc.) was then added followed by ten minutes of mixing. Finally, about 1.1 g of 28% aqueous ammonium hydroxide was added dropwise until the pH reached 7.0.

Following addition of the water and stabilizer composition, the addition funnel was removed and replaced with a sub-surface nitrogen inlet. Agitation was resumed at 250 rpm. The contents of the flask were mixed for 15 minutes while nitrogen was bubbled through at a rapid rate. The sub-surface nitrogen line was then removed and a nitrogen blanket was maintained above the condenser throughout the reaction. The contents were mixed at 250 rpm for an additional 15-30 minutes. The contents were then heated to 60° C. over a 30-40 minute period. The onset of polymerization was detected by a sharp increase in temperature above 60° C. This polymerization exotherm was allowed to help heat the reaction from 60° C. to 82° C. Each reaction was then held at 82° C. for two hours before cooling to below 30° C. The contents were then discharged.

The microsphere product obtained was a free-flowing, aqueous microsphere suspension that separated on standing to form two layers. The top layer was a concentrated suspension of polymeric microspheres and the lower layer consisted mainly of water. All suspensions were mixed thoroughly before testing was carried out.

### Example 2

Adhesive Formulations

This example illustrates adhesive formulations prepared using the microsphere suspension described in Example 1.

0.4 grams of 14% ammonium hydroxide solution was added to 100 grams of a microsphere suspension having a solids content of approximately 35%, and mixed at 130-160 rpm using a flat-blade (paddle) mixer for 10 minutes. Carbotac 26222 (available from B. F.Goodrich) was then added, in the following amounts: 7 grams (Sample 1), 5 grams (Sample 2), 4 grams (Sample 3), 3 grams (Sample 4) and 0 grams (Sample 5, no low Tg binder). These were mixed for 15 minutes. Nacrylic CP3650 (available from National Starch and Chemical Company) was then added, in the following amounts: 0 grams (Sample 1, no high Tg binder), 2 grams (Sample 2) 3 grams (Sample 3), 4 (Sample 4), and 7 grams (Sample 5). Samples 1 through 4 remained free-flowing while Sample 5 underwent immediate coagulation.

Samples 1 through 4 were further mixed for 15 minutes. Next, 0.7 grams Acrysol ASE-95 NP (available from Rohm and Haas) was added and mixed for 15 minutes. Then 0.07 grams Acrysol 75 (available from Rohm and Haas) was added, and mixed for 15 minutes more. Finally, additional ammonium hydroxide was added where necessary to adjust the pH to between 8.5 and 9.0. These samples were coated onto 2 mil clear polypropylene film using a knife over roll coating method oven-dried to give a dry adhesive coat weight of 9-10 lb/ream. These were cut into 1×6 inch strips and adhered to stainless steel panels, and allowed to age on the panels under controlled conditions for the following amounts of time: 20 minutes, 24 hours, 1 week, 1 week at 140° F., and 1 month. The strips were tested for 180° peel strength using a Sintech 1/D instrument with a 10 Newton load cell. In Table 2, peel values are shown in ounces per inch, each value being the average of three trials.

TABLE 2

| Sample | 20 mins | 24 hour | 1 week | 1 month | 1 week |
|---|---|---|---|---|---|
| No. | ambient | ambient | ambient | ambient | 140° F. |
| 1 | 3.13 | 3.54 | 3.90 | 3.31 | 6.30 |
| 2 | 2.79 | 3.52 | 3.36 | 4.48 | 4.48 |
| 3 | 1.53 | 1.72 | 1.21 | 1.70 | 2.73 |
| 4 | 0.67 | 0.77 | 0.87 | 0.87 | 1.46 |

The results show that by increasing the ratio of Nacrylic CP 3650 (manufacturer's calculated Tg=+52° C.) to Carbotac 26222 (manufacturer's calculated Tg=−55° C.) decreases the peel value compared to reference Sample 1 in cases where the total amount of binder is approximately constant.

### Example 3

This example illustrates the use of higher Tg binders to reduce the peel force of a commercial microsphere adhesive product (Sample 6) that already contains a lower Tg binder. Sample 6 is a formulated microsphere adhesive of about 35% solids available from National Starch and Chemical Company under the trade name MULTI-LOK 38-454A. MULTI-LOK 38-454A contains about 12% (dry weight basis) of a low Tg binder (Tg <−20° C.).

Sample 7 was prepared by adding 10 grams of DUROSET® C-325 to 50 grams of MULTI-LOK 38-454A. Sample 8 was prepared by adding 10 grams of RESYN® 1025 to 50 grams of MULTI-LOK 38-454A. Sample 9 was prepared by adding 10 grams of DUROSET® E-200 to 50 grams of MULTI-LOK 38-454A. After mixing Samples 7-9 for 5 minutes, the adhesive was wiped onto photocopier paper. The paper was allowed to dry and the tack was assessed using a simple “thumb tack” test.

The dry films from Samples 7 and 8 had extremely low tack while Sample 9 had moderately low tack, indicating tack reduction compared to the unmodified MULTI-LOK 38-454A film which was aggressively tacky. In the Samples 7-9 the amount of higher Tg binder was about 23-24%, the total amount of binder was about 32-33%, and the ratio of lower Tg to higher Tg binder was about 1 to 2.5, all on a dry weight basis.

Sample 10 was prepared by adding 30 grams of NACRYLIC CP3600 to 300 grams of MULTI-LOK 38-454A. Sample 11 was prepared by adding 33 grams of NACRYLIC CP3650 to 300 grams of MULTI-LOK 38-454A. After mixing the samples for 15 minutes, coatings were made onto Russell Field 60 lb paper using a meyer rod. The dry coating weight was measured, 90° peel tests from stainless steel were carried out, and probe tack measurements were made. The results were compared to a control consisting of MULTI-LOK 38-454A with no additional additives (Sample 6). These results are shown in Table 3.

TABLE 3

| | Sample 6 | Sample 10 | Sample 11 |
|---|---|---|---|
| coat weight (lbs/ream) | 8.9 | 9.6 | 10.2 |
| 90° peel (oz/in), 20 min dwell time | 4.8 | 3.7 | 0.5 |
| 90° peel (oz/in), 1 wk humidity aged | 7.6 | 8.8 | 2.0 |
| tack (grams) | 24.7 | 39.3 | 17.8 |
| total binder (% dry weight) | 12 | 23% | 22% |
| higher Tg binder (% dry weight) | 0 | 12.5% | 11% |
| ratio lower Tg:higher Tg binder | N/A | 1:1.2 | 1:1.1 |
| (dry weight) | | | |

Samples 12-16 were prepared by mixing 2.5, 5.0, 7.6, 10.0 and 15.0 grams, respectively, of NACRYLIC CP3650 with 300 grams of MULTI-LOK 38-454A. Coatings were prepared as before. Adhesive coat weights were approximately 8-10 lbs/ream, coated by meyer rod onto the glossy side of 60-lb C1S label paper from Russel Field. Peel testing was done at 90° on stainless steel at 12 in/min. Peel testing was carried out. Results are shown in Table 4.

TABLE 4

| | Sample | Sample | Sample | Sample | Sample | Sample |
|---|---|---|---|---|---|---|
| | 6 | 12 | 13 | 14 | 15 | 16 |
| amount NACRYLIC | 0 | 2.5 | 5.0 | 7.6 | 10 | 15 |
| CP3650 per 300 g | | | | | | |
| MULTI-LOK 38-454A | | | | | | |
| 90° peel (oz/in), | 8.0 | 9.7 | 6.7 | 6.1 | 4.8 | 2.3 |
| 20 min dwell time | | | | | | |
| 90° peel (oz/in), | 9.3 | 9.9 | 6.7 | 8.3 | 5.3 | 2.2 |
| 24 hour dwell time | | | | | | |
| 90° peel (oz/in), | 7.5 | 7.3 | 9.0 | 6.0 | 5.3 | 3.3 |
| 1 week dwell time | | | | | | |
| 90° peel (oz/in), | 9.9 | 9.2 | 7.4 | 5.0 | 6.2 | 4.0 |
| 2 week dwell time | | | | | | |
| 90° peel (oz/in), | 14.1 | 11.9 | 13.0 | 6.5 | 10.1 | 5.4 |
| 1 week dwell time, 95 | | | | | | |
| RH, 100° F. | | | | | | |
| 90° peel (oz/in), | 16.3 | 15.5 | 13.2 | 7.3 | 10.2 | 7.9 |
| 2 week dwell time, | | | | | | |
| 95 RH, 100° F. | | | | | | |
| tack (grams) | 24.0 | 36.1 | 50.6 | 33.1 | 32.1 | 32.3 |

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. An adhesive comprising acrylic microspheres and a binder component, said binder component comprising a first binder and a second binder, said first and second binders having Tgs separated by at least about 20° C.

2. The adhesive of claim 1 wherein said first binder and said second binder have Tgs separated by at least about 60° C.

3. The adhesive of claim 1 comprising from about 1% to about 60% on a dry wt basis of said binder.

4. The adhesive of claim 3 comprising from about 5% to about 20% on a dry wt basis of said binder.

5. The adhesive of claim 1 wherein the ratio of said first binder to said second binder is 1:10 to 20:1.

6. The adhesive of claim 1 wherein at least one of said binders is an emulsion polymer binder.

7. The adhesive of claim 6 wherein the emulsion polymer is a pressure sensitive adhesive binder.

8. The adhesive of claim 1 which is a removable adhesive.

9. The adhesive of claim 8 which is a repositionable adhesive.

10. A method of modifying the adhesive performance of an adhesive composition comprising acrylic microspheres and a first binder, said method comprising adding to said adhesive composition a modifying binder wherein the Tg of the first binder and the modifying binder are separated by at least about 20° C., wherein the modifying binder is added in an amount effective to modify the adhesive performance.

11. The method of claim 10 wherein the adhesive performance modified is tack and/or peel.

12. The method of claim 10 wherein the first binder has a Tg at least about 20° C. lower than the modifying binder.

13. The method of claim 10 wherein the first binder has a Tg at least about 20° C. higher than the modifying binder.

14. An article of manufacture prepared using an adhesive modified in accordance with claim 10.
